(19) United States
(12) Patent Application Publication
(10) Pub. No.: US 2006/0248096 A1
(43) Pub. Date: Nov. 2, 2006

(54) Early detection and warning systems and methods

(75) Inventor: Bernd G. Adam, Frankfurt am Main (DE)

Correspondence Address: WHITE & CASE LLP;PATENT DEPARTMENT, 1155 AVENUE OF THE AMERICAS, NEW YORK, NY, 10036, US

(73) Assignee: Adam Unternehmensberatung GmbH

(21) Appl. No.: 11/119,435

(22) Filed: Apr. 28, 2005

(51) Int. Cl. G06F 7/00; G06F 17/00

(52) U.S. Cl. 707/100

(57) ABSTRACT

Systems and methods embodying the present invention permit the identification of early warning conditions affecting characteristics of interest of non-physical entities, such as companies, and transmission of associated alerts or messages when pre-selected conditions are found to be satisfied for such characteristics. In addition, a quantification approach according to the present invention permits its tools to be applied to unstructured free texts.

### FIELD OF THE INVENTION

The present invention relates, in general, to methods and systems for early detection and warning and, in particular, to computational methods for predicting the states of selected entities, such as non-physical entities, and advance detection of conditions that may affect them.

### BACKGROUND OF THE INVENTION

Long the subject of computer and other quantitative models, the behavior of physical entities has been susceptible to prediction, though at varying levels of fidelity, for many years. Less attention, if any, has been paid to predicting the state or condition of entities the behavior of which is not predominantly physical.

The difference may be attributable, at least in part, to the comparative ease with which the features of physical systems, as well as the states they enter and transition between, can be identified and quantitatively measured and to the efforts devoted by physicists, applied mathematicians, and engineers since the late 18^{th} century to developing mathematical accounts of how such physical entities behave.

By contrast, a characteristic shared by many non-physical entities is that they enter and move between states that may be more difficult to directly identify and measure, at least quantitatively, than those of a physical entity. Even when the non-physical entities may have characteristics capable of being directly measured, access to the measurements may be limited or altogether unavailable. For example, an economic entity, such as a business, is likely to maintain a record of cash flows, a balance sheet, or other documents evidencing what might be thought of as the vital statistics of the entity. Yet, even so, would-be third party analysts are often forced to reckon with a poverty of available information upon which to base a measurement or other assessment, particularly if the entity is closely held.

A wide range of entities or systems of potential interest therefore tend to suffer from a certain opacity, both as to their state as well as to their future trajectory across relevant measures over time. This obscurity, in turn, limits the ability of decision makers to detect or predict when these entities will enter regimes that would endanger them or their actual or perceived value. Examples of non-physical entities, for present purposes, include but are not limited to: ones that may be economic entities, such as companies or other businesses, governmental and other organizations, markets, technologies, types of products, assets or asset classes (examples of which include equities, debt or other fixed income, derivative, asset-backed or other security; intellectual property; commodities; energy; tradeable pollution credit; distressed debt; publicly issued license right; real estate or other asset or asset class); populations; assessments; measurements or states of physical entities; non-physical models, such as mathematical or computer models, of a physical or non-physical entities; psychological entities; legal entities; or any other entity which may or may not correspond to a physical entity but which itself has at least some aspects that are not physical.

### SUMMARY OF THE INVENTION

Embodiments of systems and methods according to the present invention provide various means for evaluation or assessment of entities, of a non-physical nature, or that are otherwise difficult to measure directly. This assessment or evaluation, in turn, permits the identification, and even the prediction, of conditions, the knowledge of which would have great utility, but that might otherwise be unavailable. Systems and methods embodying the various aspects of the present invention in effect provide assessments through indirect measurements based upon an analysis of publicly and privately available data, preferably though not exclusively available through electronic transmission, over the internet or other network, or through other means of high speed delivery. Aspects of the present invention enable the generation of a predictive model of the entity of interest through an essentially inductive approach, and the application of the model to generate assessments on the basis of which decisions about the entity can be made, or inferences can be drawn.

Embodiments of other aspects of the present invention provide means to address the evaluation or assessment of non-physical entities which are characterized in publicly or privately accessible data sources as non-quantitative data. The evaluation or assessment involves transforming non-quantitative data, potentially of no immediately apparent link to the assessment, into quantitative data upon which the assessment can be made and situation-appropriate action undertaken.

In an embodiment of one aspect of the present invention, a computer-implemented method assesses a characteristic of a non-physical entity and generates an early warning message with respect to a behavior of a characteristic of the non-physical entity relative to a threshold criterion. The method comprising the following steps: retrieving data from at least one electronic data source, where the retrieved data includes data relevant to the characteristic of the non-physical entity; using the computer, analyzing the retrieved data to identify at least one pre-selected indicator for the characteristic among the data; based on the identified at least one indicator, modeling on the computer a change in the characteristic; determining on the computer whether the modeled change in the characteristic satisfies the threshold criterion; and if the change in the characteristic satisfies the threshold criterion, generating an early warning message notifying of the satisfaction of the criterion.

In an embodiment of another aspect of the present invention, a computer system assesses a characteristic of an economic entity and generates an early warning message with respect to the behavior of a characteristic of the entity relative to a threshold criterion. The system comprises several components. A processor coupled to a network and configured for receiving data from a plurality of sources over the network, and for receiving instructions from, and transmitting results to, clients over the network. The processor is configured to receive data from the plurality of sources, analyze the received data to identify at least one indicator for the characteristic among the data; based on the at least one indicator, model a change in the characteristic; determine whether the modeled change in the characteristic satisfies the threshold criterion; if the change in the characteristic satisfies the threshold criterion, and generate an early warning message notifying of the satisfaction of the criterion. The system also comprises a data storage device coupled to the processor for storing and retrieving information relating to the early warning message.

An embodiment of another aspect of the present invention comprises a computer-implemented method for receiving an early warning message from a service provider host with respect to a behavior of a characteristic of a non-physical entity relative to a threshold criterion, where satisfaction of the criterion is associated with the occurrence of an actual condition affecting the non-physical entity. The method comprises the steps of: transmitting over a network to the service provider host computer a request for an early warning message relating to the behavior of the pre-selected non-physical entity relative to the threshold criterion; and receiving at the computer over the network from the host computer, in advance of an occurrence of the actual condition of the non-physical entity relative to the threshold criterion, data representing a risk of the occurrence of the condition at a subsequent time, the data generated based on a computer analysis of a plurality of electronic data sources.

An embodiment of another aspect of the present invention involves a computer system for receiving an early warning message from a service provider host with respect to a behavior of a characteristic of an economic entity relative to a threshold criterion, the computer system comprises a processor coupled to a network and configured to transmit over the network to the service provider host computer a client request for an early warning message relating to the behavior of the pre-selected economic entity relative to the threshold criterion, and receive at the computer over the network from the host computer, in advance of an occurrence of a condition of the economic entity relative to the threshold criterion, data representing a risk of the occurrence of the condition at a subsequent time, the data generated based on a computer analysis of a plurality of electronic data sources. The system also comprises an output device coupled to the processor for delivery to the client of at least a subset of the data representing the risk.

In an embodiment of another aspect of the present invention, a computer-implemented process for generating an early warning information product with respect to a condition of a non-physical entity. The process comprises the steps of retrieving data from at least one electronic data source, using the computer, analyzing the data to locate at least one of a pre-selected set of indicators among the data, based on the located at least one indicator, simulating on the computer a change in the condition of the non-physical entity, determining on the computer whether the change in the condition satisfies a threshold criterion, and if the change in the condition satisfies the threshold criterion, generating a warning information product comprising data representing the satisfaction of the threshold criterion by the condition of the non-physical entity, for representation in a computer storage medium.

Yet another aspect of the present invention, relates to a computer system for assessing a characteristic of an economic entity and generating an early warning message with respect to the behavior of a characteristic of the entity relative to a threshold criterion. The system comprises means for retrieving data from at least one electronic data source, the retrieved data including data relevant to the characteristic of the economic entity; means for analyzing the retrieved data to yield at least one pre-selected indicator for the characteristic among the data; means for modeling a change in the characteristic based on the located at least one indicator; means for determining on the computer whether the modeled change in the characteristic satisfies the threshold criterion; and means for generating an early warning message notifying of the satisfaction of the criterion, if the change in the characteristic satisfies the threshold criterion.

Another aspect of the present invention involves a computer-implemented method for assessment of a credit condition of an economic entity and generating an early warning message with respect to the behavior of the credit condition relative to a threshold criterion. The method comprises the steps of retrieving data from at least one electronic data source, the retrieved data including data relevant to the credit condition of the economic entity, using the computer, analyzing the retrieved data to yield at least one pre-selected indicator for the credit condition among the data; based on the located at least one indicator, modeling on the computer a change in the credit condition; determining on the computer whether the modeled change in the credit condition satisfies the threshold criterion, and if the change in the credit condition satisfies the threshold criterion, generating an early warning message notifying of the satisfaction of the criterion.

In yet another aspect of the present invention, a computer-implemented method for receiving early credit risk warnings comprises the steps of transmitting over a network to a service provider host computer a request for a credit risk early warning message relating to a pre-selected economic entity; and receiving at the computer over the network from the host computer, in advance of an adverse credit condition, an early warning message comprising data representing a risk of the adverse credit condition.

A further aspect of the present invention relates to a computer-implemented process for generating a credit risk condition warning product with respect to a business entity. The process comprises the steps of retrieving data, comprising unstructured text, from at least one electronic data source, using the computer, analyzing the data to locate at least one of a pre-selected set of indicators among the data, based on the located at least one indicator, simulating on the computer a change in the credit risk of the business entity, determining on the computer whether the change in the credit risk satisfies a threshold criterion, and if the change in the credit risk satisfies the threshold criterion, generating a credit risk warning product comprising a computer storage medium containing data representing the credit risk condition for the business entity.

Still another aspect of the present invention provides for a computer-implemented method for assessment of a characteristic of an economic asset and generating an early warning message with respect to the behavior of a characteristic of the asset relative to a threshold criterion and facilitating a buy or sell decision with respect to the asset. The method comprises the steps of: retrieving data from at least one electronic data source, the retrieved data including data relevant to the value of the asset; using the computer, analyzing the retrieved data to yield at least one pre-selected indicator for the value of the asset among the data; based on the located at least one indicator, modeling on the computer a change in the value of the asset; determining on the computer whether the modeled change in the value of the asset satisfies the threshold criterion; and if the change in the value of the asset satisfies the threshold criterion, generating an early warning message notifying of the satisfaction of the criterion and facilitating a buy or sell decision with respect to the asset.

Still another aspect of the present invention relates to a computer-implemented method for assessment of a measure of diffusion of a technology and generating a message with respect to the behavior of the diffusion of the technology relative to a threshold criterion. The method comprises the steps of retrieving data from at least one electronic data source, the retrieved data including data relevant to an assessment of the diffusion of the technology; using the computer, analyzing the retrieved data to yield at least one pre-selected indicator for the diffusion of the technology among the data; based on the located at least one indicator, modeling on the computer a change in the diffusion of the technology; determining on the computer whether the modeled change in the diffusion of the technology satisfies the threshold criterion; and if the change in the value of the diffusion of the technology satisfies the threshold criterion, generating a message notifying of the satisfaction of the criterion.

Other objects and advantages of the various aspects of the present invention will be apparent to those of skill in the art having reference to the description and figures, as well as to the appended claims.

### BRIEF DESCRIPTION OF THE DRAWINGS

FIG. 1 is a block diagram of an embodiment of aspects of a system and method in accordance with the present invention at a high level of abstraction.

FIG. 2 is a block diagram illustrating functional aspects of the present invention associated with the operation of a server for early detection and warning in an embodiment of the present invention.

FIG. 3 is a flowchart of an embodiment of a method according to aspects of the present invention at a high level of abstraction.

FIG. 4 shows a flowchart of an embodiment of another method according aspects of the present invention, at a lower level of abstraction than shown in FIG. 3.

FIG. 5 shows a graph identifying the application of an embodiment of a method for early detection and warning according to the present invention.

### DETAILED DESCRIPTION

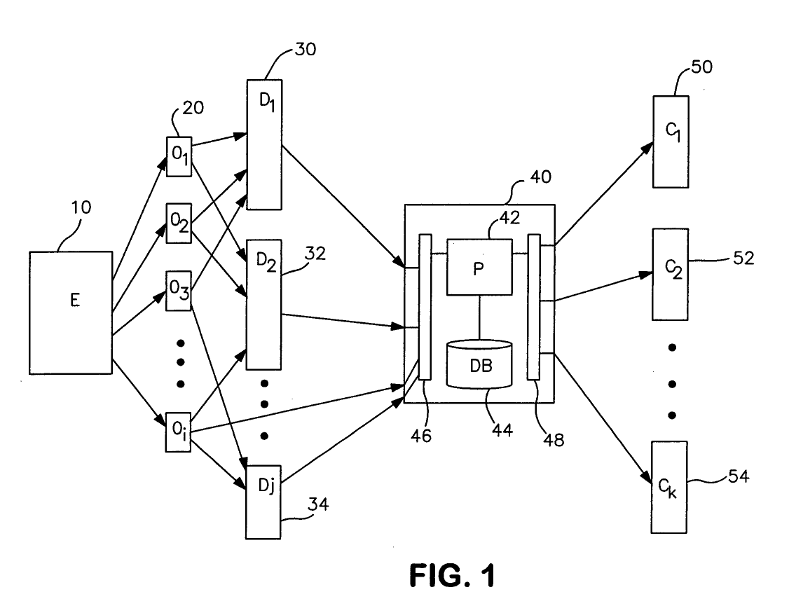

FIG. 1 shows an embodiment of a system 40 for detecting conditions associated with a non-physical entity E 10. Although E could be any non-physical entity, including without limitation, an economic entity like a company or an asset, it could also be a non-physical entity that does not admit of direct measurements of characteristics of interest. In particular, E 10 could be an entity as to which all available information is in a non-quantitative form, but which non-quantitative information according to the invention serves as a basis for quantization or other transformation or mapping into a quantitative domain.

One embodiment of various aspects of the present invention is shown and described in FIG. 1 in connection with an example in which aspects of a system according to the present invention, and entities with which it communicates, are shown at a high level of abstraction. In FIG. 1, entity E 10 is the source of various data that can become grist for the press, as discussed below. Embodiments in which a plurality of entities other than E 10 are involved are also within the scope of the present invention.

Any number of observers O₁, O₂, O₃, O, . . . , Oᵢ, collectively shown by reference numeral 20, gather data from or about entity E 10, as well as about other entities (not-shown). The observers may include, but are not limited to, representative print and broadcast journalism sources. They could also include private individuals, so-called “bloggers,” or any others who purport to gather and make available reports on entities such as E 10. An observer could be a subset of, or associated with, entity E 10 itself. Moreover, the observations do not generally include direct observations of measures of interest, since such measures might not require approaches according to the present invention.

Although collection of data about entity E 10 by observers 20 is shown occurring via a network, which could be without limitation the worldwide public internet, collection of data of potential relevance to the entity E 10 could also be gathered directly or through an alternative mechanism. Data collected by observers 20 can, in general, be made available to the public or to subscribers through data providers D1, D2, . . . , Dj 30, 32 and 34. Examples of data providers 30, 32 and 34 include rating agencies, internet portals, company databases, tickers, associations/industry sectors, official information, worldwide and local press, technology press, emails, and so forth. Data providers 30, 32 and 34, as shown, can in general receive data from a plurality of observers 20, and the observers 20 can, in general, report data to more than one data provider 30, 32 and 34. In addition, as in the case of observer Oᵢ, some observers 20 can themselves act as data providers, forwarding data directly without the need for a separate, intervening data provider D₁, D₂, . . . , Dⱼ, 30, 32 or 34.

Data providers 30 furnish data on request to system 40, in which the detection of conditions affecting E 10 and the generation of early warning messages regarding such detection, is performed. System 40, which may also be referred to as a service provider host or similar appellation, in the illustrated embodiment includes a processor (P) 42. The term “processor” may be used interchangeably with the term “computer” and references to a “computer,” in this description and the appended claims, can refer to one or more computers or processors. Processor 42 in general is in communication with a database 44 for storing intermediate and final results, among other things; other architectures directed to the same functionality are also, though not shown, within the scope of the present invention. System 40 also may include an interface or preprocessing functionality 46, which would operate, as selected, upon incoming data from data providers 30, 32 and 34. System 40 also includes an interface 48 for permitting a customer C₁, C₂, . . . , Cₖ, 50, 52 and 54 to communicate with system 40, specify preferences for receipt of early warnings regarding particular entities E 10, pick up early warning messages (unless they are delivered via a “push” model, e.g., email) and otherwise communicate with system 40. Early warning messages may be considered, and referred to herein, as information products that can be generated and transmitted to customers of the service providers that generate them, via the client devices that are in communication with the services providers, also as described.

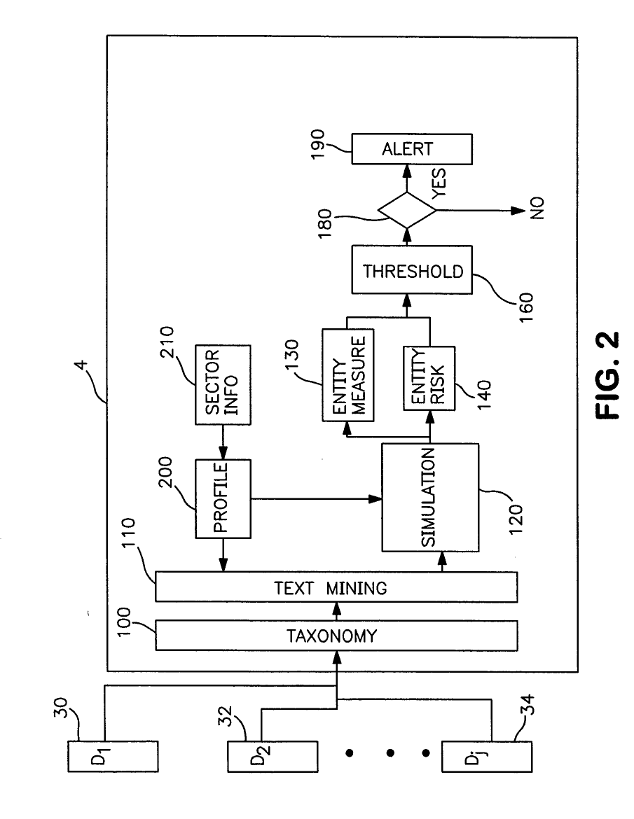

FIG. 2 shows an embodiment of functionality associated with system 40, shown in communication with data providers 30. Data retrieved from data sources D₁, D₂, . . . , Dⱼ, 30, 32, 34 are processed, organized and potentially discarded according to a taxonomy 100 specified taking into account the type of entity E 10 is. If E 10 were a company, for example, taxonomy 100 would include categories for companies, industries, technologies and so on. Following application of taxonomy 100, a text mining function 110 is applied to the retrieved data, also as described in greater length below, in order to glean from the incoming data portions from which intelligence about entity E 10 is expected to be inferred with an acceptable level of trustworthiness. In particular, according to an aspect of the present invention, incoming data, which can be, e.g., unstructured free text and which may contain no quantitative information, serves as the basis for deriving one or more quantitative figures for characteristics or parameters of entity E 10. As discussed below, the transformation from a linguistic domain to a quantitative domain is accomplished through the application of any of a variety of approaches, including statistical methods (e.g., trees, General Discriminant Analysis (GDA)), Support Vector Machines (e.g., learning machines), meta languages, tagging, etc.

The results of text mining 110, which for example may be in the form of one or more database records including meta language triggers or the like, serve as input to a simulation 120. Simulation 120, generally though not necessarily on the basis of mathematical models, is also informed by a profile function 200 corresponding to entity E 10. A profile 200 provides a structured description used to set up simulation 120 to run properly for the entity E 10 under analysis. Profile 200, which can itself be informed or updated with sector information 210 (corresponding to the category or class of entity E 10), is used as a source of input for setting up and running text mining functionality 110.

Results of simulation 120, in the illustrated embodiment, can be used to develop an estimate or assessment of indicators or measures of interest 130 for the entity. In addition, since indicators or measures are typically a random variable, an estimate or assessment of the distribution of that random variable, or the degree of risk associated with the measure for that entity, at 140, is also computed. Such results as are generated according to entity measure 130 and entity risk 140 then serve as a basis for conducting a threshold operation 160 (e.g., without limitation, a migration matrix, which assigns or revises a statistical distribution of values for the (random variable) indicator or entity measure). At 180, a condition is tested as to whether the indicator or entity measure exceeds a pre-selected threshold, for example, or satisfies a pre-selected criterion. The pre-selected threshold or criterion may optionally be client-selected or client-specific. In this way, early detection of a condition affecting entity E 10 can be achieved. If so, an alert or early warning message or the like is generated at 190, which can be stored in database 44 and/or transmitted to one or more customers 50, 52, . . . ,54 that have requested to be provided with such warning.

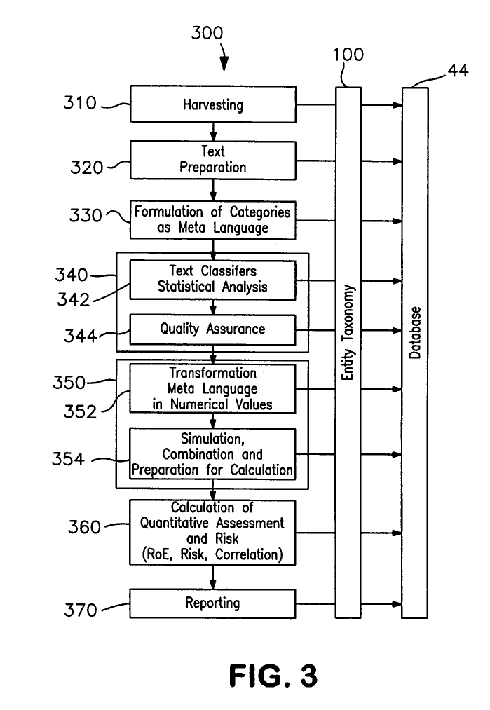

A flowchart 300 for the operation of a method according to an embodiment of the present invention is shown in FIG. 3. Shown in parallel with the flowchart 300 are entity taxonomy 100 and database 44, to make more clear how the steps associated with the illustrated embodiment can be carried out. At step 310, data from one or more data providers 30, 32 and 34 from FIG. 1, are “harvested”. The harvesting 310, in this embodiment, applies the taxonomy 100, which contains specific structure for the entity E 10 under analysis, as well as the class of the entity. If the entity E 10 were a company, taxonomy 100 would take into account information regarding the company, the industry in which it resides, the technologies, if any, with which it is involved, and so on. Application of the taxonomy 100 permits organization and winnowing of data, which is eventually stored in database 44.

A text preparation step 320 then is run. An embodiment of this step entails the application of grammars, e.g., to “understand” the semantics of the text by application of grammatical rules associated with the natural language of the data received from the data providers 30, 32, 34. Text preparation can also involve named entity recognition, word sense disambiguation and other known techniques of natural language processing. Results are stored in database 44, retrievable for subsequent processing.

At step 330, categories are formulated as “meta languages” in this embodiment. A meta language creates a simplified, in a sense, conceptual linguistic representation, which, although generally representable in a particular natural language, can nevertheless serve as a kind of universal representation of linguistic data. Application of the meta language can, among other things, capture the appropriate sense of the analyzed original text sources. Particulars of a meta language can be expected to depend on the particulars of the nature of the domain from which entity E 10 has been selected.

At 340, directed to deployment and training, text classifiers 342 and quality assurance 344 steps are invoked. The text classifier step, in one embodiment, uses statistical methods (e.g., trees, GDA), SVM (as described above) to developed a classified body of text, which upon quality assurance 344, is stored in database 44. Quality assurance 344, in the illustrated embodiment, involves application of, e.g., alternative text classifiers, voting, random sample analysis to increase the likelihood that the output of the text classifiers step 342 passes muster. As for examples of criteria and means, these include respectively and without limitation: contradiction between different methods of text classifiers; and structuring the text in paragraphs, sentences and parts, with a specific named entity context. Results are stored or storable at database 44.

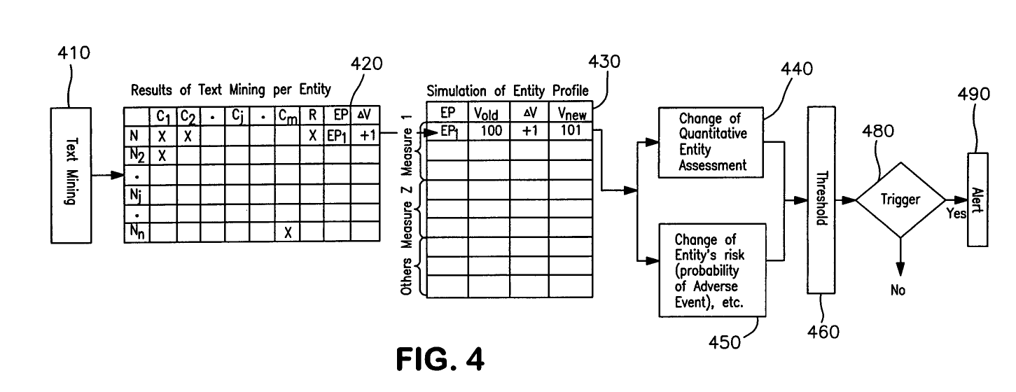

The output of the highly processed data from 340 serves as the basis for a transformation from a non-mathematical or non-quantitative domain (such as unstructured free text) into a mathematical or quantitative domain at 350, in accordance with the embodiment, and as described in greater detail below in FIG. 4. Step 350 of the embodiment involves a first substep 352, where transformation occurs by mapping or otherwise transforming to one or more indicators or measures, e.g., in numerical values, from meta language. Simulation 352, in one embodiment, can involve simulation of the generated numerical values, combination of different categories and preparation for the calculation.

At step 360, in an embodiment of this aspect of the present invention, a step is invoked in which a calculation of a quantitative assessment, such as a comparison against a pre-selected threshold or a test to determine satisfaction of a criteria and concomitant risk measure are computed and stored. Reporting of results occurs at step 370.

An embodiment of certain other aspects of the present invention, relating to a method 400 for the transformation of observed or gathered data, such as free text or other generally non-quantitative sources, into quantitative results, is shown in FIG. 4. The results of a text mining step 410, described in greater detail above, are placed in a data structure 420. In the illustrated embodiment, the data structure includes, without limitation, a matrix or other n-dimensional array to compare it with past text mining results. In the illustrated embodiment, the array includes two dimensions. On the horizontal or row space dimension of the illustrated data structure 420 are a plurality of message types, Nᵢ, of the meta language, which message types may be fed by any information sources. These may be any information sources, including those discussed in connection with FIG. 1, and each may contain news or other information that may, through application of an approach according to the present invention, imply or point to a change in a profile (comprising one or more characteristics) of the entity being investigated. On the vertical or column space dimension of data structure 420 are: a number of categories, Cⱼ (j=1, . . . m); a variable R representing the number of documents for that message type Nᵢ; an item or characteristic entity profile EP to be simulated or calculated (such as the NPV of a company); and a change in value ΔV of the item or characteristic EP.

The variable R can be used in support of an approach that, in effect, counts results in the meta language items, Nᵢ. The quantity R, or other suitable measure, can be used to give specific information types of the meta language non-linear weights according to how widespread their coverage in the media happens to be.

EP (entity profile) represents an item or characteristic of interest associated with the entity under scrutiny, and represents what will be simulated and or calculated in accordance with one or more methods of the present invention. In this context, EP will often be, though is not necessarily, an item or characteristic that is difficult or impossible to ascertain directly by examining the entity. This, as described above, is a motivation for an approach according to the present invention, and leads to an assessment of the characteristic indirectly through the observation of data sources containing reports of the occurrences from which information regarding the item or characteristic of interest, EP, can be inferred.

According to an aspect of the present invention, EP is computed, inferred, generated or otherwise arrived at, generally as a quantitative or numerical result, but also possibly a logical result, on the basis of the non-quantitative and non-logical results of the text mining 410. Various approaches can be used, within the scope of the present invention, to effectuate this transformation yielding EP. Generally speaking, the approaches may involve the prior creation of mapping or transformation means based on familiarity and experience with the entity under study and the surrounding problem domain. For example, one approach can place the text mining results into regimes or sets that are assigned quantitative values based on experience particular to the type of entity being studied, and possibly the entity itself. Another approach could involve a look-up table, in which the table is entered with the results of the text mining 410 and produces the measure EP. Statistical models and rule-based approaches can be embedded in, or invoked by, this transformation process. In addition, the mapping can imply different grades of detail: One rule changes a quantitative value by a predefined amount; another rule increases the probability that a quantitative value will improve or worsen; a third increases the probability that a quantitative value will change irrespective of the direction (the overall risk will increase).

A final item in the column space of the matrix 420 of method 400 is a ΔV, which in an embodiment of this aspect of the present invention represents a transformation in the quantitative value of the final item, a characteristic measure that is or can be quantified. Several boxes, such as the upper left hand corner of data structure 420, contain Xs. Each X merely indicates the correspondence across the message type Nᵢ between that source and the detected presence within it of content corresponding to the particular category, Cⱼ.

When the results of the text mining for the entity are complete, and data structure 420, or its equivalent, has been populated, a profile for the entity is simulated. In a sense, this simulation maps from one or more measures to the various types of meta-language. To this extent, a “profile” is the set of all EP's of interest for the entity. The simulation can be performed or tracked with respect to a data structure 430, which need not be of the precise form shown, and need not be distinct from data structure 420, but which has sufficient functionality to permit the approach of this aspect of the present invention.

The various EP values for the entity appear in the left hand column, and can be organized into groups. In the illustration, these can be various measures (1, 2, and so on), or there can be other results. If the entity were a company, for example, one set of measures could be those of the sort one would find on a corporate balance sheet. Another set could be those associated with corporate profit and loss (P&L) figures. In a second column or portion of the data structure, a set of old values, V_{old}, corresponding to the measures EP, are recorded before any information derived from the media are simulated. In this example, for EP₁, V_{old} is 100. In a further column or portion of the data structure, the value ΔV, change in the value of the item or characteristic EP is represented. From these values, V_{new} is computed, in this case by summing V_{old} and ΔV, though other mathematical approaches may be appropriate depending upon the entity, the item or characteristic, and so forth.

Based upon a simulation of the characteristic or profile of the entity being investigated, with respect to data structure 430, a quantitative entity assessment is made at 440. For example, a user conducting the study may have specified conditions or criteria or thresholds, which may be of a quantitative or logical nature, against which particular items, characteristics, or other measures of the entity are compared. The results of the comparison, which are specific to the type of entity under study, can be said to represent an assessment of the entity, which becomes available for use in threshold determination 460. In an embodiment of the present invention pertaining to business entity credit assessment, this involves the use of one or more threshold criteria. Likewise, also based on simulation 430, a risk for the entity with respect to any of the items, characteristics, measures, EP, are determined at 450, which also may be used in the threshold criterion 460 (e.g., in business credit assessment contexts, a migration matrix).

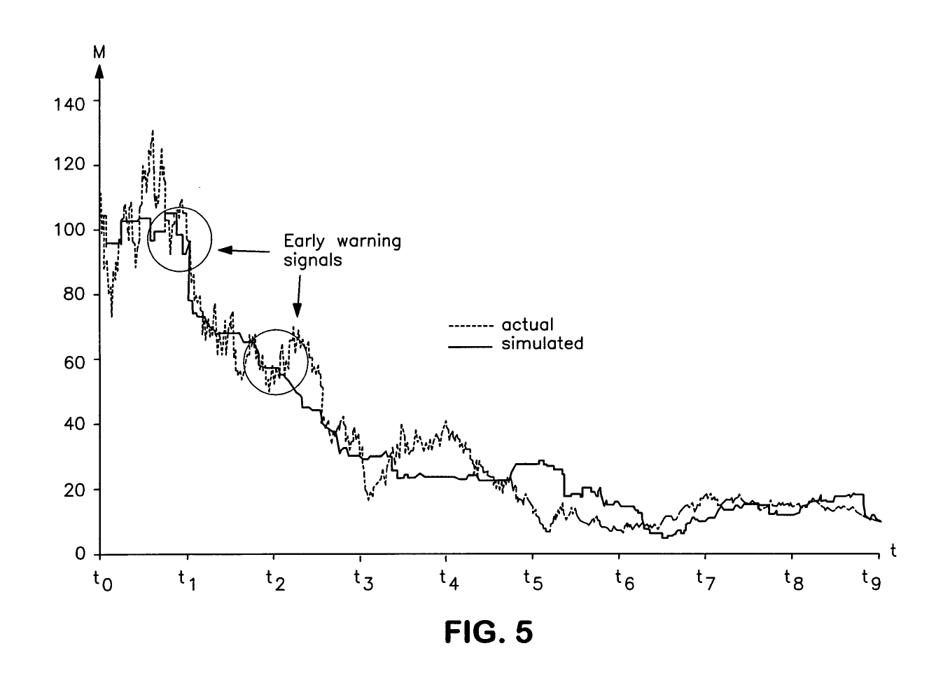

The results of an example of the application of systems and methods according to the present invention are shown in FIG. 5, in which simulated results are compared, after the fact, to actual results. In the example, the value of EP corresponds with a measurement M of an entity characteristic is the ordinate, which tracks as a function of time, t, on the abscissa. A first plot of the characteristic demonstrates the value of the entity derived from the stock markets as it progresses throughout a range, overlaid with a second plot showing the variation of a simulated characteristic (value of EP for the same entity). This result is obtainable from the data structure 430. V_{old} are simulated EP values from the previous day's calculation; V_{new} are simulated EP values from the present day's calculation based newly received information. When the simulated characteristic V_{new} is known over a desired range, it is possible to perform an assessment of the simulated characteristic relative to a reference or threshold, which can be a single value or a variable value, such as a rate or acceleration, or other reference against which a variable could be compared.

In the illustrated example, two early warning signals were detected based on the simulated results, each shown within the indicated circles on FIG. 5. In both instances, the simulated measure M of V dropped precipitately—and at a greater rate than a threshold rate which was stored, for purposes of comparison, in memory accessible to quantitative entity assessment function 440. The second early warning signal, occurring just after time t₂, provides a particularly clear example of an early warning that would not be derivable from the face of the actual data. That is, while the actual data is climbing, the simulated value is dropping precipitately, suggesting that the actual behavior may be based upon an erroneous market analysis.

The assessment based on a plot of the sort provided in FIG. 5 could also be done visually, in that a user, e.g., Cₖ 50 of FIG. 1, could receive this delivery of the plot, e.g., electronically over a network, and could “eyeball” the results. More preferable, perhaps, is that the assessment can be done computationally, therefore being accomplished quickly, across many characteristics and many entities, and reported quickly as well. In accordance with an aspect of the present invention, if the assessment relative to the criterion of interest, or to the reference or threshold value or function, produces a particular result defined in advance as worthy of an alert, then an alert or warning message can be generated (e.g., by processor P of system 40) for transmission to one or more customers C₁, C₂, . . . , Cₖ and can be written to database DB of system 40. By way of illustration, if the entity were a company and the entity characteristic V of EP were the stock price of the company, the fact of the sudden dive of the simulated value (which could occur an indefinite time before the actual simulated time, though with decreasing fidelity as the time between the simulated performance and the actual date being simulated grows) can be detected, measured, assessed by comparison to the criteria or threshold and then serve as the basis for an early warning or alert to the one or more customers interested in the performance of the stock of that entity. The simulated stock price, and its fluctuations of certain magnitudes and steepness relative to threshold criteria, may permit an inference, such as at quantitative assessment 440, of a lack of credit worthiness of the company. The nature of the alert or warning can also be categorized according to a level of severity, which could, for one example, be computed as a function of the steepness of the expected change (e.g., drop) in the stock price or other characteristic being simulated.

The methods and systems according to the present invention can be employed with respect to any of a wide variety of phenomena.

Although warnings and alerts are often regarded as having to do with negative or undesirable situations that one would be advised to avoid, the present invention is not so limited. Rather, the systems and methods according to the present invention can also be used to identify, and warn of, expected favorable conditions, such as identifying an opportunity for a prospective advantage.

Other objects, advantages and embodiments of the various aspects of the present invention will be apparent to those who are skilled in the field of the invention and are within the scope of the appended claims. For example, but without limitation, structural or functional elements might be rearranged, or method steps reordered, consistent with the present invention. Similarly, principles according to the present invention, and systems and methods that embody them, could be applied to other examples, which, even if not specifically described here in detail, would nevertheless be within the scope of one or more claims set forth below.

What is claimed is:

1. A computer-implemented method for assessment of a characteristic of a non-physical entity and for generating an early warning message with respect to a behavior of a characteristic of the non-physical entity relative to a threshold criterion, the method comprising the steps of:
retrieving data from at least one electronic data source, the retrieved data including data relevant to the characteristic of the non-physical entity;
using the computer, analyzing the retrieved data to identify at least one pre-selected indicator for the characteristic among the data;
based on the identified at least one indicator, modeling on the computer a change in the characteristic;
determining on the computer whether the modeled change in the characteristic satisfies the threshold criterion; and
if the change in the characteristic satisfies the threshold criterion, generating an early warning message notifying of the satisfaction of the criterion.

2. The method according to claim 1, further comprising the step, following identification of the at least one indicator, of computing a numerical value based on the indicator and wherein the step of modeling the change in the characteristic based on the indicator uses the numerical value in modeling the change in the characteristic.

3. The method according to claim 1, wherein the retrieved data comprises text data and the at least one pre-selected indicator comprises classified text.

4. The method according to claim 1, wherein the retrieved data and the indicator comprises textual data, the method further comprising the step of transforming the textual data into at least one quantitative measure capable of being compared with the threshold criterion.

5. The method according to claim 1, wherein the at least one electronic data source comprises a plurality of news sources.

6. The method according to claim 4, wherein the step of transforming the textual data into at least one quantitative measure is performed prior to modeling on the computer a change in the characteristic, and the modeling step comprises an operation upon the quantitative measure.

7. The method according to claim 6, wherein the operation upon the quantitative measure comprises a mathematical operation.

8. The method according to claim 1, wherein the non-physical entity comprises an economic entity.

9. The method according to claim 8, wherein the non-physical entity comprises a company and the characteristic comprises a measure of the credit worthiness of the company.

10. A computer system for assessment of a characteristic of an economic entity and generating an early warning message with respect to the behavior of a characteristic of the entity relative to a threshold criterion, the system comprising:
a processor coupled to a network and configured for receiving data from a plurality of sources over the network, and receiving instructions from, and transmitting results to, clients over the network, the processor configured to:
receive data from the plurality of sources;
analyze the received data to identify at least one indicator for the characteristic among the data;
based on the at least one indicator, model a change in the characteristic;
determine whether the modeled change in the characteristic satisfies the threshold criterion; and
if the change in the characteristic satisfies the threshold criterion, generating an early warning message notifying of the satisfaction of the criterion; and
a data storage device coupled to the processor for storing and retrieving information relating to the early warning message.

11. The computer system according to claim 10, wherein the processor is further configured, following the identification of the at least one indicator, to compute a numerical value based on the indicator, and, when modeling the change in the characteristic based on the indicator, to use the numerical value in modeling the change in the characteristic.

12. The computer system according to claim 10, wherein the received data comprises text data and the identified at least one identified indicator comprises classified text.

13. The computer system according to claim 11, wherein the received data and the identified indicator comprise textual data, and wherein the processor is further configured to transform the textual data into at least one quantitative measure capable of being compared with the threshold criterion.

14. The method according to claim 13, wherein the processor is configured to transform the textual data into at least one quantitative measure prior to modeling on the computer a change in the characteristic, and wherein the processor is configured, when modeling the change in characteristic, to operate upon the quantitative measure.

15. The method according to claim 14, wherein the sources of data comprise news sources and the received textual data comprise news stories.

16. The method according to claim 14, wherein the operation upon the quantitative measure comprises a mathematical operation.

17. The method according to claim 10, wherein the non-physical entity comprises an economic entity.

18. The method according to claim 17, wherein the non-physical entity comprises a company and the characteristic comprises a measure of the credit worthiness of the company.

19. A computer-implemented method for receiving an early warning message from a service provider host with respect to a behavior of a characteristic of a non-physical entity relative to a threshold criterion, where satisfaction of the criterion is associated with the occurrence of an actual condition affecting the non-physical entity, the method comprising the steps of:
transmitting over a network to the service provider host computer a request for an early warning message relating to the behavior of the pre-selected non-physical entity relative to the threshold criterion; and
receiving at the computer over the network from the host computer, in advance of an occurrence of the actual condition of the non-physical entity relative to the threshold criterion, data representing a risk of the occurrence of the condition at a subsequent time, the data generated based on a computer analysis of a plurality of electronic data sources.

20. The computer-implemented method according to claim 19, wherein the computer analysis comprises an automated text analysis and the plurality of electronic data sources comprises at least one electronic news source.

21. The computer-implemented method according to claim 20, wherein the non-physical entity comprises an economic entity.

22. The computer-implemented method according to claim 21, wherein the economic entity comprises a business entity.

23. The computer-implemented method according to claim 21, wherein the economic entity comprises a technology.

24. The computer-implemented method according to claim 21, wherein the economic entity comprises at least one of the group consisting of an asset and an asset class.

25. A computer system for receiving an early warning message from a service provider host with respect to a behavior of a characteristic of an economic entity relative to a threshold criterion, the system comprising:
a processor coupled to a network and configured to:
transmit over the network to the service provider host computer a client request for an early warning message relating to the behavior of the pre-selected economic entity relative to the threshold criterion;
receive over the network from the host computer, in advance of an occurrence of a condition of the economic entity relative to the threshold criterion, data representing a risk of the occurrence of the condition at a subsequent time, the data generated based on a computer analysis of a plurality of electronic data sources; and
an output device coupled to the processor for delivery to the client of at least a subset of the data representing the risk.

26. The computer system according to claim 23, wherein the computer analysis comprises an automated text analysis and the plurality of electronic data sources comprises at least one electronic news source.

27. The computer system according to claim 26, wherein the economic entity comprises a business entity.

28. The computer system according to claim 26, wherein the economic entity comprises a technology.

29. The computer-implemented method according to claim 26, wherein the economic entity comprises at least one of the group consisting of an asset and an asset class.

30. A computer-implemented process for generating an early warning information product with respect to a condition of a non-physical entity; the process comprising the steps of:
retrieving data from at least one electronic data source;
using the computer, analyzing the data to locate at least one of a pre-selected set of indicators among the data;
based on the located at least one indicator, simulating on the computer a change in the condition of the non-physical entity;
determining on the computer whether the change in the condition satisfies a threshold criterion; and
if the change in the condition satisfies the threshold criterion, generating a warning information product comprising data representing the satisfaction of the threshold criterion by the condition of the non-physical entity, for representation in a computer storage medium.

31. The process according to claim 30, wherein the data comprises unstructured text.

32. The process according to claim 30, wherein the at least one electronic data source comprises a news source.

33. The process according to claim 31 wherein the non-physical entity comprises an economic entity.

34. The process according to claim 33, wherein the economic entity comprises a business entity.

35. The process according to claim 34, wherein the condition comprises a credit-worthiness assessment associated with the business entity.

36. A computer system for assessing a characteristic of an economic entity and generating an early warning message with respect to the behavior of a characteristic of the entity relative to a threshold criterion, the system comprising:
means for retrieving data from at least one electronic data source, the retrieved data including data relevant to the characteristic of the economic entity;
means for analyzing the retrieved data to yield at least one pre-selected indicator for the characteristic among the data;
means for modeling a change in the characteristic based on the located at least one indicator;
means for determining on the computer whether the modeled change in the characteristic satisfies the threshold criterion; and
means for generating an early warning message notifying of the satisfaction of the criterion, if the change in the characteristic satisfies the threshold criterion.

37. The computer system according to claim 36, wherein the means for analyzing the retrieved data comprises a means for text mining.

38. The computer system according to claim 36, wherein the means for modeling a change comprises a simulation of an entity profile.

39. The computer system according to claim 38, wherein the means for determining on the computer whether the modeled change in the characteristic satisfies the threshold criterion comprises a migration matrix.

40. The computer system according to claim 36, wherein the economic entity comprises a business entity.

41. A computer-implemented method for assessment of a credit condition of an economic entity and generating an early warning message with respect to the behavior of the credit condition relative to a threshold criterion, the method comprising the steps of:
retrieving data from at least one electronic data source, the retrieved data including data relevant to the credit condition of the economic entity;
using the computer, analyzing the retrieved data to yield at least one pre-selected indicator for the credit condition among the data;
based on the located at least one indicator, modeling on the computer a change in the credit condition;
determining on the computer whether the modeled change in the credit condition satisfies the threshold criterion; and
if the change in the credit condition satisfies the threshold criterion, generating an early warning message notifying of the satisfaction of the criterion.

42. The method according to claim 41, further comprising the step, following location of the at least one indicator, of computing a numerical value based on the indicator and wherein the step of modeling the change in credit condition based on the indicator uses the numerical value in modeling the change in the credit condition.

43. The method according to claim 42, wherein the retrieved data comprises textual data and the at least one pre-selected indicator comprises classified text.

44. The method according to claim 42, wherein the retrieved data and the indicator comprise textual data, the method further comprising the step of transforming the textual data into at least one quantitative measure capable of being compared with the threshold criterion.

45. The method according to claim 44, wherein the step of transforming the textual data into at least one quantitative measure is performed prior to modeling on the computer a change in the credit condition, and the modeling step comprises an operation upon the quantitative measure.

46. The method according to claim 45, wherein the operation upon the quantitative measure comprises a mathematical operation.

47. A computer-implemented method for receiving early credit risk warnings comprising the steps of:
transmitting over a network to a service provider host computer a request for a credit risk early warning message relating to a pre-selected economic entity; and
receiving at the computer over the network from the host computer, in advance of an adverse credit condition, an early warning message comprising data representing a risk of the adverse credit condition.

48. The method according to claim 47, wherein the data is generated based on automated text analysis of a plurality of electronic news sources.

49. A computer-implemented process for generating a credit risk condition warning product with respect to a business entity, the process comprising the steps of:
retrieving data from at least one electronic data source, the data comprising unstructured text;
using the computer, analyzing the data to locate at least one of a pre-selected set of indicators among the data;
based on the located at least one indicator, simulating on the computer a change in the credit risk of the business entity;
determining on the computer whether the change in the credit risk satisfies a threshold criterion; and
if the change in the credit risk satisfies the threshold criterion, generating a credit risk warning product comprising a computer storage medium containing data representing the credit risk condition for the business entity.

50. A computer-implemented method for assessment of a characteristic of an economic asset and generating an early warning message with respect to the behavior of a characteristic of the asset relative to a threshold criterion and facilitating a buy or sell decision with respect to the asset, the method comprising the steps of:
retrieving data from at least one electronic data source, the retrieved data including data relevant to the value of the asset;
using the computer, analyzing the retrieved data to yield at least one pre-selected indicator for the value of the asset among the data;
based on the located at least one indicator, modeling on the computer a change in the value of the asset;
determining on the computer whether the modeled change in the value of the asset satisfies the threshold criterion; and
if the change in the value of the asset satisfies the threshold criterion, generating an early warning message notifying of the satisfaction of the criterion and facilitating a buy or sell decision with respect to the asset.

51. The method according to claim 50, further comprising the step, following location of the at least one indicator, of computing a numerical value based on the indicator and wherein the step of modeling the change in asset value based on the indicator uses the numerical value in modeling the change.

52. The method according to claim 50, wherein the retrieved data comprises textual data and the at least one pre-selected indicator comprises classified text.

53. The method according to claim 50, wherein the retrieved data and the indicator comprises textual data, the method further comprising the step of transforming the textual data into at least one quantitative measure capable of being compared with the threshold criterion.

54. The method according to claim 53, wherein the step of transforming the textual data into at least one quantitative measure is performed prior to modeling on the computer a change in the asset value, and the modeling step comprises an operation upon the quantitative measure.

55. The method according to claim 54, wherein the operation upon the quantitative measure comprises a mathematical operation.

56. The method according to claim 51, wherein the asset comprises an ownership interest in a business entity.

57. The method according to claim 56, wherein the ownership interest in the business entity comprises an equity share in the business entity.

58. The method according to claim 50, wherein the asset comprises at least one security.

59. The method according to claim 58, wherein the at least one security comprises at least one share of stock in a publicly traded company.

60. The method according to claim 58, wherein the at least one security comprises a fixed income security.

61. The method according to claim 58, wherein the at least one security comprises a debt instrument issued by a business entity.

62. The method according to claim 58, wherein the at least one security comprises a derivative instrument.

63. The method according to claim 58, wherein the at least one security comprises an asset-backed security.

64. The method according to claim 50, wherein the asset comprises a right in intellectual property.

65. The method according to claim 50, wherein the asset comprises a commodity.

66. The method according to claim 50, wherein the asset comprises an interest in energy.

67. The method according to claim 50, wherein the asset comprises distressed debt.

68. The method according to claim 50, wherein the asset comprises a tradeable pollution credit.

69. The method according to claim 50, wherein the asset comprises an interest in a publicly issued license right.

70. The method according to claim 50, wherein the data relevant to the value of the asset comprise an expected value of the asset.

71. The method according to claim 50, wherein the data relevant to the value of the assets comprises a probability distribution for the value of the asset.

72. A computer-implemented method for assessment of a measure of diffusion of a technology and generating a message with respect to the behavior of the diffusion of the technology relative to a threshold criterion, the method comprising the steps of:
retrieving data from at least one electronic data source, the retrieved data including data relevant to an assessment of the diffusion of the technology;
using the computer, analyzing the retrieved data to yield at least one pre-selected indicator for the diffusion of the technology among the data;
based on the located at least one indicator, modeling on the computer a change in the diffusion of the technology;
determining on the computer whether the modeled change in the diffusion of the technology satisfies the threshold criterion; and
if the change in the value of the diffusion of the technology satisfies the threshold criterion, generating a message notifying of the satisfaction of the criterion.

73. The method according to claim 72, further comprising the step, following location of the at least one indicator, of computing a numerical value based on the indicator and wherein the step of modeling the change in the diffusion of the technology based on the indicator uses the numerical value in modeling the change.

74. The method according to claim 72, wherein the retrieved data comprises textual data and the at least one pre-selected indicator comprises classified text.

75. The method according to claim 72, wherein the retrieved data and the indicator comprises textual data, the method further comprising the step of transforming the textual data into at least one quantitative measure capable of being compared with the threshold criterion.

76. The method according to claim 75, wherein the step of transforming the textual data into at least one quantitative measure is performed prior to modeling on the computer a change in the diffusion of the technology, and the modeling step comprises an operation upon the quantitative measure.

77. The method according to claim 76, wherein the operation upon the quantitative measure comprises a mathematical operation.
